(19) United States
(12) Patent Application Publication
(10) Pub. No.: US 2006/0041935 A1
(43) Pub. Date: Feb. 23, 2006

(54) Methodology for configuring network firewall

(76) Inventors: James Walter Conley, Herndon, VA (US); Eric B. Cole, Leesburg, VA (US)

Correspondence Address: MARTIN & HENSON, P.C., 9250 W 5TH AVENUE, SUITE 200, LAKEWOOD, CO, 80226, US

(21) Appl. No.: 10/920,699

(22) Filed: Aug. 17, 2004

(51) Int. Cl. G06F 15/16

(52) U.S. Cl. 726/11

(57) ABSTRACT

Provided is a method for configuring filter parameters for a network firewall whereby information corresponding to a core set of data parameters is extracted from each of a plurality of data packets traversing a network segment. The extracted information is stored as a respective log entry within a database. A set of proposed filter parameters is established from the log entries and a final set of filter parameters is generated from the proposed filter parameters.

### BACKGROUND OF THE INVENTION

The present invention generally relates to the field of network security, and more particularly concerns firewall implementation techniques for regulating access to information on a network.

The term “firewall” refers to the implementation of security policies designed to secure a network from intrusion. A network firewall, analogous to a barrier around ones property, serves to protect a private network or a home computer system, for example, from infiltration by unwanted intruders. The firewall may be a program, or hardware device such a router, which filters information coming through an Internet connection. It can be customized to add or remove filtering based on various criteria, such as IP addresses, domain names, protocols, ports, or specific words and phrases. If an incoming packet of information is flagged by the filters, it is not allowed through the firewall. More involved implementations can comprise combinations of routers and servers, each performing some type of firewall processing.

Firewalls are widely used to provide individuals secure access to the Internet while isolating a company's public web server, for example, from its internal network. Firewalls are also widely employed internally within networks. Companies will often place a firewall at every connection to the Internet, such as every T1 or T3 line coming into the company. At these vulnerability points, it is not uncommon to see the installed firewall implemented in hardware, while software firewalls are often employed to protect individual workstations. On a corporate infrastructure, a variety of security rules can be implemented to enhance protection. For example, while the corporate network might include hundreds of computers, it may be that only a single one is configured to receive public FTP traffic, while all other computers on the network are prevented from establishing FTP connections. Similar rules can be established for FTP servers, web servers, telnet servers, etc. In addition, the company can configure its firewall to regulate how employees use the network, such as controlling their ability to connect to websites, controlling their ability to transmit files over the corporate network, and so on.

Network firewalls operate at different layers of the protocol stack and use different criteria to restrict traffic. The lower in the protocol stack a packet is intercepted, the more secure the firewall. Most firewalls are configured to be permissive for internal systems, but very restrictive for systems outside the firewall. It is common practice to restrict inbound traffic from the Internet to only established connections. However, outbound traffic is often allowed from internal users on any port without restrictions. In a more restrictive environment, the firewall may only allow certain protocols to be used on outbound connections. For example, the firewall may only allow outbound HTTP for web browsing (port 80), POP3 for downloading email (port 110), and SMTP for sending email (port 25). This is a more secure strategy since it limits what internal users can do and is being implemented in more environments. The denied protocols are considered to be unsafe by the firewall administrator. An example of a denied protocol might be Instant Messaging (IM) traffic since an organization might view IM traffic as a security risk.

Firewalls typically fall into three broad categories: packet filters, application level gateways and stateful, multilayer inspection firewalls. Packet filtering firewalls work at the network level of the OSI model (or the IP layer of TCP/IP), and are usually part of a router firewall. This is the lowest layer at which a firewall can work. At this layer a firewall can determine whether a packet is from a trusted source, but cannot be concerned with what it contains or what other packets are associated with it. In a packet filtering firewall, each packet is compared to a set of criteria before being forwarded. This criteria can include source and destination IP addresses, source and destination port numbers, and protocol used. Depending on the packet and the criteria, the firewall can drop the packet, forward it, or send a message to the originator. The advantage of packet filtering firewalls is their low cost and low impact on network performance. Most routers support packet filtering. Even if other firewalls are used, implementing packet filtering at the router level affords an initial degree of security at a low network layer. This type of firewall only works at the network layer, however, and does not support sophisticated rule based models.

At the application level, firewalls know a great deal about what is going on and can be very selective in granting access. Application level gateways, also called proxy servers, are application specific and can filter packets at the application layer of the OSI reference model. Incoming or outgoing packets cannot access services for which there is no proxy. For example, an application level gateway that is configured to be a web proxy will not allow any ftp, gopher, telnet or other traffic through. Because proxy servers examine packets at the application layer, they can filter application specific commands. This cannot be accomplished with packet filtering firewalls since they know nothing about information at the application level. Application level gateways can also be used to log user activity and logins. While they do offer a high level of security, they can have a significant impact on network performance due to context switches which can slow down network access dramatically. They are also not transparent to end-users and require manual configuration of each client computer.

Stateful, multilayer inspection firewalls combine the aspects of these other types of firewalls. That is, they filter packets at the network layer, determine whether session packets are legitimate, and evaluate contents of packets at the application layer. They allow direct connection between client and host, alleviating the problem caused by the lack of transparency of application level gateways. They rely on algorithms to recognize and process application layer data instead of running application specific proxies. Stateful, multilayer inspection firewalls offer a high level of security, good performance and transparency to end-users. They are expensive, however, and due to their complexity are potentially less secure than simpler types of firewalls if not administered by competent personnel.

One product about which the inventor has some awareness does appear to provide some level of automation and convenience to a network administrator configuring a firewall. “Mason” is a software package available in the public domain under the GNU GPL license. Mason is executable on a Linux platform that is configured as a gateway, and it interactively develops rules to be run on the same gateway device. More particularly, Mason is a tool that interactively configures a firewall using Linux ipfwadm or ipchains firewalling. The program is left to run for a period of time on the device which will ultimately be the firewall. In the interim, the network administrator establishes the types of connections which are desirable for the firewall to support, as well as those which should be blocked. Mason will then provide a list of firewall rules to permit and deny those connections. According to information obtained on the product, it was specifically designed to provide a convenient way for those acquainted with the Linux system to build a reasonably good packet filtering firewall. Mason presumably handles some of the nuances associated with configuring a low level packet filtering firewall, such that the user need only follow instructions in order to run supported TCP/IP applications. To this end, the program's script converts log entries produced by the Linux kernel into lipfwadm or ipchains commands which can be used in the firewall. While, generally speaking, Mason is a system which will observe traffic and generate rules, it is very limited in how it operates and in the rules it generates. The rules that it generates are very basic and simplistic rules. Moreover, it is designed to work with a specific firewall and therefore all traffic must pass through it.

Another product, known as Firewall Builder is a multi-source policy manager. It is part of SourceForge project, an open source software development website providing a centralized projects repository for open source developers to control and manage software development. The Firewall Builder project manages the firewall rules sets for various firewalls. Information obtained from the website www.fwbuilder.org describes the Firewall Builder as a multi-platform configuration and management tool consisting of a GUI and a set of policy compliers for various firewall platforms. It uses an object-oriented approach, allowing an administrator to maintain a database of network objects, with policy editing accomplished by drag-and-drop operations. At present, Firewall Builders supports IP tables, IP filter, OpenBSD PF and Cisco PIX. Conveniently, the product is capable of generating a configuration file for any supported target firewall platform based on the same policy created in its GUI. Multiple firewall management capability is provided through the use of the same network object database. As such, changes made to an object are immediately reflected in the policy of all firewalls using the object. In operation, backend software components deduce various parameters for the firewall policy rules using information available through the network and service objects. From these parameters, the backends of software components generate code for the target firewall.

It can be appreciated from the above that there are numerous approaches to implementing firewall policies through both hardware and software. For the most part, however, initially configuring the firewall's filtering policies can be time consuming and tedious, particularly for network administrators responsible for large organizations. It is believed that little attention has been specifically directed to alleviating this drawback. Accordingly, despite the advances which have been made in improving firewall performance, relatively sparse attention has been directed to enhance the ease with which they can be configured. Thus, there remains a need to provide a new and improved approach to firewall configuration which couples a suitable level of automation with interactive feedback from the network administrator. There is a further need to provide such an approach which can be ported across various platforms, and which can help streamline the configuration process, The present invention is primarily directed to meeting these needs.

### BRIEF SUMMARY OF THE INVENTION

The present invention provides a method for configuring filter parameters for a network firewall. According to one exemplary embodiment of this method network traffic, characterized by a stream of data packets traversing a network segment, is monitored. This can be accomplished through the use of a suitable network sniffer, such as tcpdump. Information corresponding to a core set of data parameters is extracted from the packets and stored as a respective log entry in a storage location, such as a database. The core set of data parameters extracted from each packet preferably includes one or more of its associated source IP address, destination IP address, source LAN, destination LAN, source IP port, destination IP port, protocol and time.

A set of proposed filter parameters is then established. The proposed filter parameters are derived from the log entries, and first input which is received corresponding to a set of global firewall configuration parameters. The first input may be provided by any individual desiring to configure the firewall (referred to as the “user”), and is typically a network administrator. A set of final filter parameters are then generated based on second user input. Each final filter parameter is preferably generated by interactively interfacing with the user to receive second input which corresponds to the user's desire to either accept or reject each proposed filter parameter. Another exemplary embodiment of this methodology more particularly contemplates that extraction of information from the data packets occurs while being online, whereas establishment of the proposed and final filter parameters occurs while being offline. Storage of the associated information from each of the data packets within a suitable database may occur while being either online or offline.

Other aspects may be advantageously provided for either of the above embodiments. For example, it is preferred that the first user input be stored in a configuration file and correspond to a user's desire to regulate packet transmission characteristics based on various global criteria. This may entail, for example, a desire to either restrict or allow transmission of network traffic along the network segment based on packet direction (i.e. either inbound or outbound). Packet transmission can also be restricted or allowed based on other filtering criteria such as a source IP address, a destination IP address, a source LAN, a destination LAN, a source IP port, a destination IP port, a protocol, or even time.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 represents a high level flow diagram for the firewall configuration methodology of the present invention;

FIG. 2(a) is a diagrammatic view representatively illustrating a perimeter portion of a network in which the to-be-configured firewall will reside;

FIG. 2(b) represents the same network portion with one of its Ethernet cable links replaced with suitable components for monitoring traffic across the link and configuring a firewall;

FIG. 2(c) diagrammatically illustrates the network portion of FIGS. 2(a) & (b), as but now with permanent firewall located along the link;

FIG. 3 is a functional block diagram illustrating the preferred online and offline flow for configuring a firewall according to the present invention;

FIG. 4(a) is a listing which shows representative TCP/IP traffic, as generated by tcpdump, which can be monitored during configuration of the firewall;

FIG. 4(b) is a representative packet listing encountered by tcpdump;

FIG. 5(a) illustrates, in tabulated form, the organization of the extracted data fields within a matrix;

FIG. 5(b) illustrates, in tabulated form, representative field data extracted from a plurality of data packets, and populated into the table format of FIG. 5(a);

FIG. 6 represents a high level flowchart for computer software which implements the online processing functions for the firewall configuration methodology of the present invention; and

FIG. 7 represents a high level flowchart for computer software which implements the offline processing functions for the firewall configuration methodology of the present invention.

### DETAILED DESCRIPTION OF THE INVENTION

The present invention provides a methodology for configuring filtering parameters to be used in conjunction with a network firewall. More particularly, the configuration approach described herein automatically generates and recommends rules based on observed network traffic. Provisions are also made for providing recommendations pertaining to network address translation (NAT) and the dynamic host configuration protocol (DHCP). To these ends, functions traditionally performed by senior security professionals and network administrators can be handled instead through the automated generation of filtering parameters, at times also referred to herein as rules, for a given location along a network perimeter.

In the following detailed description, reference is made to the accompanying drawings which form a part hereof, and in which is shown by way of illustrations specific embodiments for practicing the invention. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer networks in general, and firewalls in particular. The ordinarily skilled artisan will appreciate that such terminology is employed in a descriptive sense and not a limiting sense. Where a confined meaning of a term is intended, it will be explicitly set forth or otherwise apparent from the disclosure.

Perl scripts offer a suitable and convenient programming environment for accomplishing the objectives of the present invention, particularly for prototyping. This is in part due to Perl's built in pattern matching capabilities. For wide scale distribution, other development tools offering GUI capabilities, a compiler and an interpreter in a single package might be more suitable. It should be readily recognized that suitable programming for accomplishing the objectives of the invention could be developed using several widely available programming languages with the software component(s) coded as subroutines, sub-systems, or objects depending on the language chosen. Accordingly, any particular ones discussed herein should not be interpreted to limit the environment of the present invention. Software embodying the present invention may be distributed in known manners, such as on computer-readable medium which contains the executable instructions for performing the methodologies discussed herein. Alternatively, the software may be distributed over an appropriate communications interface so that it can be installed on the user's computer system.

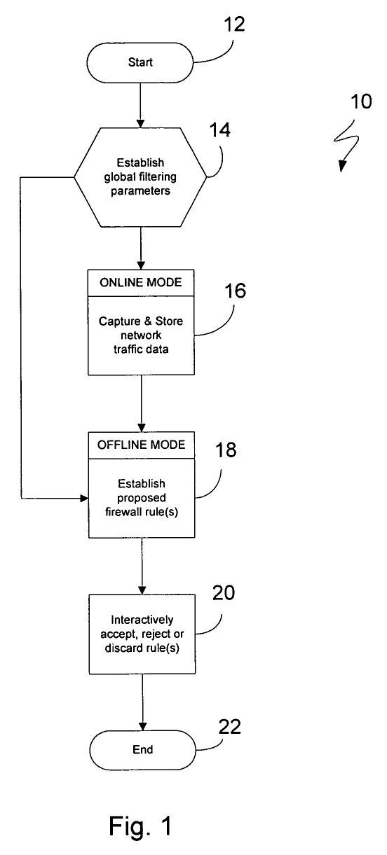

With the above in mind, and by way of introduction, reference is initially made to FIG. 1 which represents a high level flow diagram 10 for the firewall configuration methodology. Following start 12, for the firewall are established at 14. As discussed below, these global parameters correspond to first user input, likely from a network administrator. Once in online mode, network traffic data is captured and stored at 16 so that proposed firewall rule(s) can later be established at 18 in offline mode based on the global filtering parameters. These proposed rules can either be accepted, rejected or discarded at 20 through interaction with the user, thus creating a final set of rules which can be used to construct the actual firewall. flow diagram 10 then ends at 22.

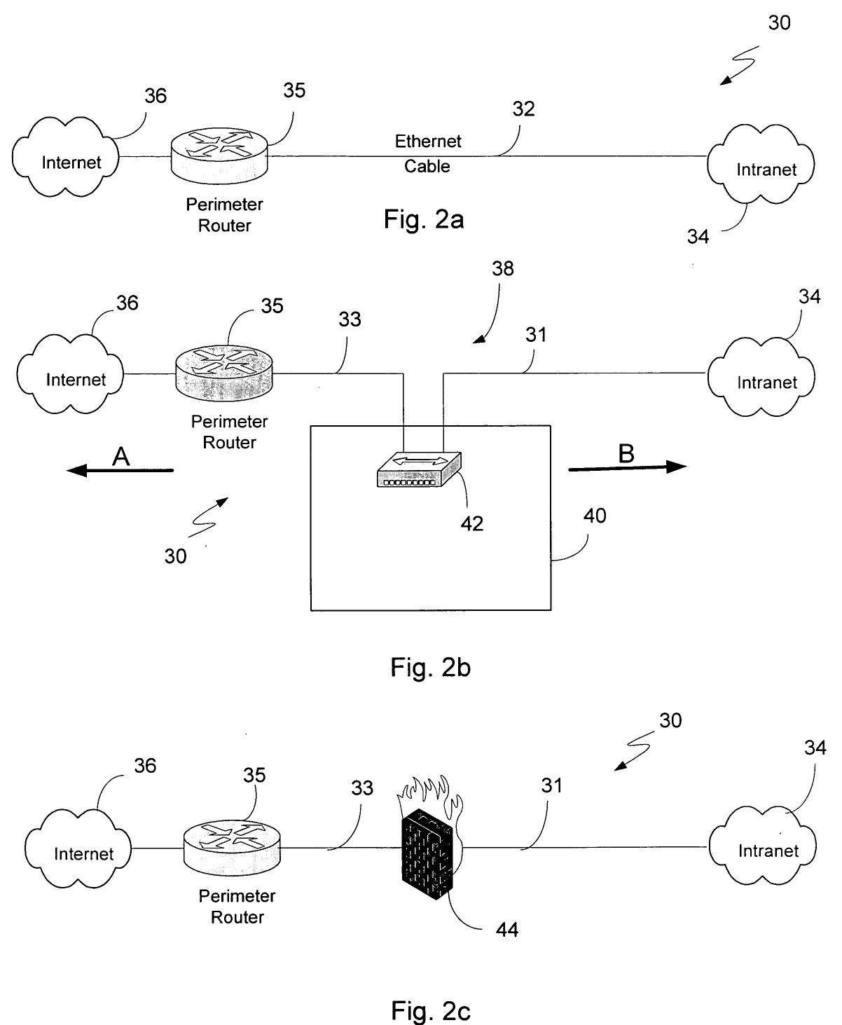

FIGS. 2(a)-2(c) diagrammatically depicts a representative operating environment for the present invention. With initial reference to FIG. 2(a), a perimeter portion 30 of a network is shown. An original network link, such as an Ethernet cable 32, separates an internal network, such as a corporate intranet 34, from an external network, such as the public Internet 36. As is often the case, a perimeter router 35 generally delineates the boundary between the public and private network segments. This area, thus, becomes an attractive location for a firewall since the network traffic reaching the internal network 34 necessarily passes through this location. It is to be understood that FIG. 2(a) only illustrates one possible architecture for a network portion at which a future firewall could reside. Indeed, the ordinarily skilled artisan will readily recognize that the to-be-configured firewall can be located at any suitable location, and indeed positioned anywhere an Ethernet cable currently exists on a network architecture.

In order to configure a firewall according to the aspects of the invention, appropriate firewall configuration components 40 may now be interfaced between intranet 34 and perimeter router 34 in place of the original Ethernet cable 32. The components are generically represented by box 40 in FIG. 2(b) since it is contemplated that they may comprise a variety of hardware device(s) which suitably adapted to accommodate the methodology teachings herein. Once installed, components 40 will passively monitor all traffic passing through the network segment, and analyze the traffic to determine the desired firewall rule set.

Preferably, components 40 incorporate an internal hub 42 which is connected between intranet 34 and perimeter router 35 by Ethernet links 31 and 33, respectively. While there can be a variety of ways to accomplish this, a convenient approach is to initially set up a properly configured gateway at the location of the future firewall, with the gateway adapted, through suitable programming, to accomplish objectives of the present invention. In this manner, the network segments are already established making it more convenient to either permanently configure the gateway to incorporate firewalling parameters, or to be swapped out in favor of another suitably programmed firewalling device, such as Cisco Pix, CheckPoint and Raptor, to name a few. In any event, it may be appreciated that a region 38 is defined between intranet 34 and perimeter router 35 such that bi-directional network traffic, characterized by a stream of data packets, traverses region 38 through hub 42. Thus, once the filter parameters for the firewall have been configured, components 40 can be replaced, if needed, with a permanent firewall as graphically represented by depiction 44 in FIG. 2(c).

In configuring the firewall, various parameters can be used to dictate the level of security desired. For example, rules can be derived based on one of the following security levels: (1) a “high” security level in which all network traffic is blocked requiring that specific rules be in place to explicitly allow traffic across the perimeter boundary; (2) a “medium” level in which all incoming traffic is blocked and only outgoing traffic which conforms to the rules sets is allowed; and (3) a “low” level in which all inbound traffic is blocked, while all outbound traffic is denied. For purposes of the above, it is to be understood that outgoing or outbound traffic refers to data packets traveling in the direction of arrow “A” in FIG. 2(b), while incoming or inbound traffic refers to data packets traversing the network segment in the direction of arrow “B”.

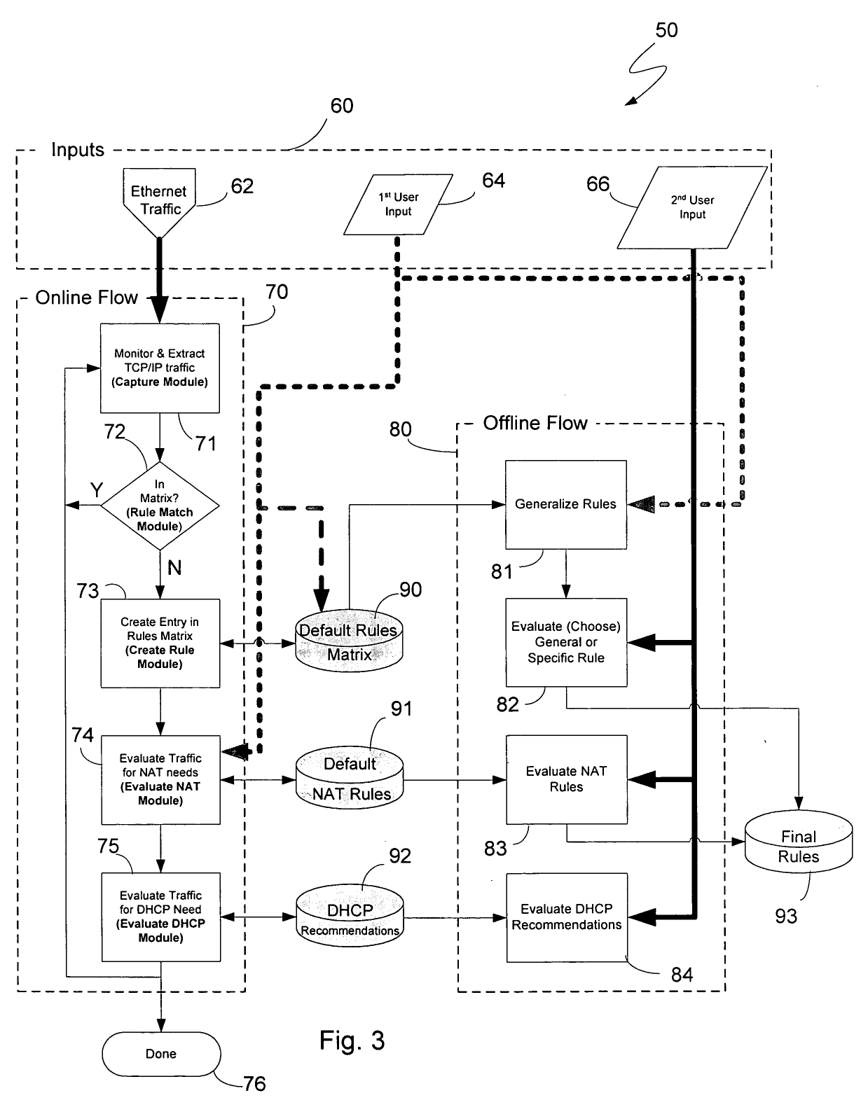

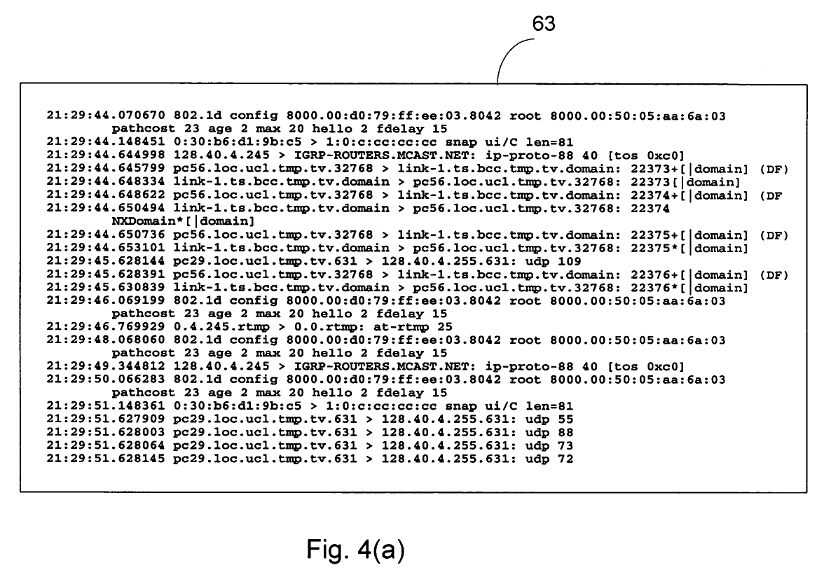

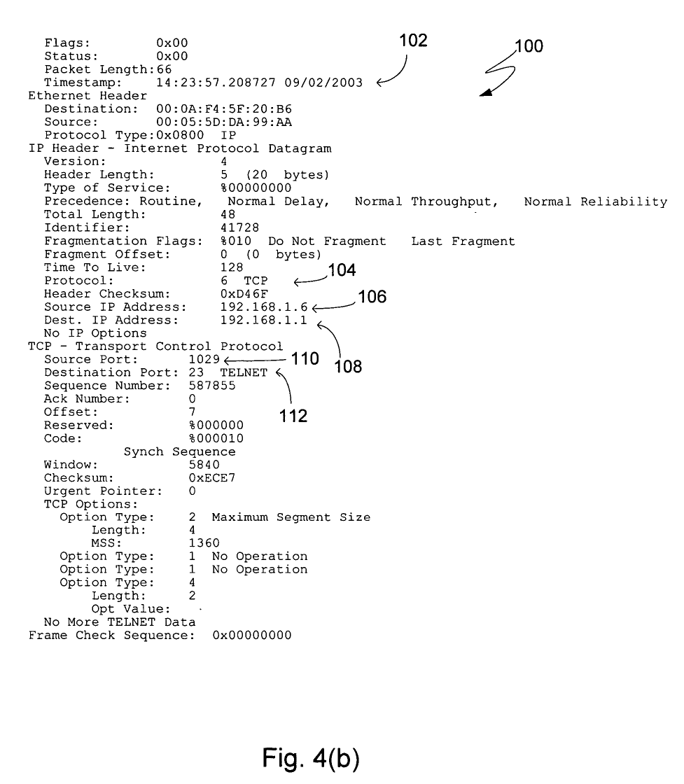

With the above context in mind, a functional block diagram 50 is shown in FIG. 3 to illustrate the online and offline flow for configuring a firewall according to the present invention. The configuration architecture preferably incorporates a plurality of inputs 60, online and offline processing flows 70 and 80, respectively, and a plurality of data storage locations, such as databases 90-93. Inputs 60 preferably comprise Ethernet traffic 62, first user input 64 that is contained in a configuration file (Cfile), and second user input 66. When the configuration components, such as represented by 40 above, are placed online, online processing 70 is initiated to monitor the traffic and extract appropriate information therefrom. For purposes of this discussion, a suitable network sniffer such as tcpdump, can be employed to sniff the network traffic. FIG. 4(a) shows a representative listing 63 of typical TCP/IP traffic which might be generated by tcpdump. Listing 63 contains both inbound and outbound traffic which can be evaluated to determine the rules needed to allow or block observed data packets which traverse the network segment of interest. Although not necessarily required, it is contemplated that the traffic can also be examined for the application NAT and DHCP, with NAT recommendations made based on traffic that is destined and originating from the local subnet.

When online, the Ethernet traffic is monitored at 71 and information is extracted from the data packets. This is preferably accomplished by a first module, referred to as a “capture module”, which can look for four types of packets, namely, TCP, UDP, ICMP packets and DHCP transactions. Associated information is extracted from each of these data packets corresponding to a core set of data parameters. Depending on the network administrator's individual preferences, this core set of data parameters may include the protocol or packet type (i.e. TCP, UDP, ICMP, or DHCP), the source and destination IP addresses for the packet, the source and destination ports for the packet, and the packet's time stamp, or any suitable combination of one or more of them. To this end, a representative packet listing 100 for a data packet such as encountered by tcpdump, is shown in FIG. 4(b). Various line items in this listing 100 identify the time stamp for the data packet at 102, the protocol at 104, the source IP address at 106, the destination IP address at 108, the source port at 110 and the destination port at 112. This information is preferably extracted from a stream of data packets (both inbound and outbound) sufficient in number based on ones subjective determination, to suitably configure firewall filtering parameters. While it may be desirable to monitor traffic for a relatively long period of time, such as a month, to obtain a worthwhile snapshot of network activity, longer or shorter examination periods could be used.

For each packet monitored, a determination is made at 72 as to whether any one or more of the extracted parameters mentioned above has already been populated as a corresponding log entry into a database of log entries, also referred to as a default rules matrix 90 in FIG. 3. This comparison functionality can be accomplished by a second module, distinguishably referred to as a “rule match module”. The extent of what parameters are compared is up to the subjective determination of the network administrator. However, for purposes of discussing the invention, it will be assumed that the administrator is interested in logging packet data corresponding to each of the field parameters discussed above and, with the exception of the timestamp, making a comparison at 72 to ascertain if of the same combination of data has been previously logged in to matrix 90. If the determination at 72 is in the affirmative, then subsequent Ethernet traffic 62 is again monitored by the capture module at 71. Otherwise, a third module, referred to as a “create rule module” is run at 73 to create a corresponding default rule that is specific to the extracted data encountered.

It is well known to those skilled in the field to appropriately configure firewall device(s) to pass or block packets based on certain criteria. Many, if not most, network administrator's restrict packet transmission only by certain protocols, by permitting or denying use of certain ports. The present invention, however, provides a baseline rules set to facilitate this effort. For example, and as described herein, it can create specific rules based on traffic actually observed, rather than simply pre-conceived notions of what types of traffic should be regulated One manner of doing this is to, by default, allow all future traffic which corresponds to previous log entries during the online examination period unless specifically rejected by the administrator, or generalized as discussed below. Thus, it is appropriate to refer to storage location 90 in FIG. 3, not only as a database of logged entries, but also as a default rules matrix.

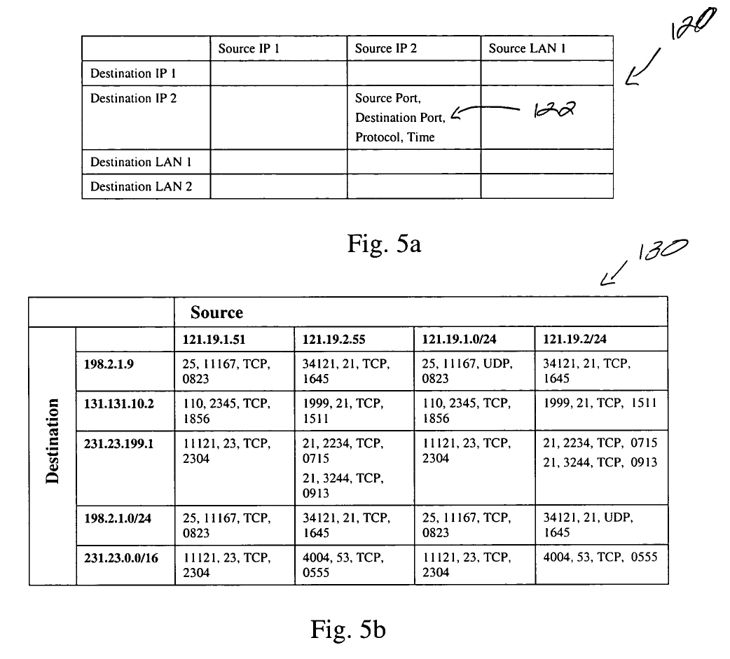

The associated information corresponding to the core set of data parameters may be organized within the database 90 as a matrix, such as visually represented by table 120 in FIG. 5(a). As may be seen in table 120 each cell, such as representative cell 122 represents a source IP (or LAN), a destination IP (or LAN), and a quadruplet of the source port, destination port, protocol and time stamp pertaining to the particular data packet encountered. Table 120 in FIG. 5(a) illustrates the format in which this associated information may be stored as a matrix, while table 130 in FIG. 5(b) shows, for a representative stream of data packets, actual data populated within the cells according to the above format. Of course, it is to be appreciated that the extracted data field populated within table 130 could be obtained by parsing the packet data detected by the tcpdump sniffer, via Perl scripting for example, to extract the desired information from each data packet. This capability is well understood in the art.

According to the online flow 70, a third module, referred to as a “evaluate NAT module”, may executed at 74. It is contemplated that this module would receive network address and network mask information derived from the IP traffic by examining broadcast messages and ARP requests. Based on this, default NAT rules could be stored in a second storage location, such as database 91. As well understood in the field, network address translation (NAT) allows a device behind a firewall to have a private address. However since it is a private address these addresses cannot directly go out on the Internet. Therefore a private address must get translated to a public address before it gets sent out on the network. There are different devices that can do this but this function is usually performed by a firewall. NATting is not something that changes so if NATting is already in place then this feature would not be useful. This feature is useful in cases were there is not an existing firewall or NAT device and all of the internal systems have public addresses. Hence, the NAT capabilities contemplated by the present invention could be optional based on the specific environment. In the case where these capabilities are employed, the tool would know the external address range, the external address of the firewall and the internal systems that are going to be switched over to private addresses. Based on this information, a rule could be established that would identify which private addresses need to be translated to what public address.

It is also contemplated that a fourth module, referred to as the “evaluate DHCP module”, could be executed at 75 to evaluate any DHCP requests that are discerned in the captured traffic and create feedback recommendations to the administrator which are store within another location 92. As is also well understood, the dynamic host configuration protocol (DHCP) is used to assign an IP address to a system when it boots. This function is rarely performed by a firewall. However, were it to be implemented in the context of the-present invention, as contemplated by FIG. 3, then it would entail observing the range of addresses that are assigned to which networks and establishing a corresponding rule based upon this.

During the offline processing 80, generalized rules are created at 81 based on the first user input 64 and information contained within the rules matrix 90. Generalization in this sense refers to the establishment of a set of proposed filter parameters based on these various inputs. For example, as mention above the first user input 64 corresponds to a global set of firewall configuration parameters and is preferably stored in a configuration file (Cfile). This global set of firewall configuration parameters may correspond to a variety of preferences of the network administrator. For example, they may include a desire to either restrict or allow transmission of network traffic along the network segment based on packet direction (i.e. inbound or outbound). In addition they may relate to a desire, with respect to each inbound data packet traversing the network segment, to either restrict or deny packet transmission based on a particular source IP address, a destination IP address, a source LAN, a destination LAN, a source port, a destination port, a protocol, or time. The same holds true with respect to each outbound data packet, and it is understood that any suitable combination of the above filtering categories can be provided with the user's particular global set being stored in the configuration file. Such input may then be retrieved for purposes of establishing the proposed filter parameters at 81. It can be appreciated then that the proposed filter parameters (i.e. the generalized rules) may then be interactively presented to the network administrator, such as through an appropriate GUI, so that an evaluation can be made at 82 based on the second user input 66 which is interactively obtained.

To briefly illustrate a few possible scenarios which are contemplated by offline flow processing steps 81 and 82, reference is again made to the packet listing of FIG. 4(b), from which can be extracted the following information:
Timestamp: 14:23:57.208727 09/02/2003
Protocol: 6 TCP
Source IP Address: 192.168.1.6
Dest. IP Address: 192.168.1.1
Source Port: 1029
Destination Port: 23 TELNET

This information is then placed into the rule matrix as a log entry item, as such:

| | | Source |
|---|---|---|
| Destination | | 192.168.1.6 |
| | 192.168.1.1 | 23, 1029, TCP, 01423 |

This information then becomes a specific default rule, such that future like traffic will be allow by default unless subsequent administrator input dictates otherwise. Alternatively, based on information previously obtained from the user and stored in the configuration file, the administrator will be given the option to generalize this specific rule by substituting “any” for the IP addresses, the ports, protocol or the time.

As another representative example, assume the administrator's input at 64 corresponds to a desire to regulate traffic by protocol alone, he/she can be presented with a listing of all protocols (i.e. port numbers) encountered during online monitoring, irrespective of other field data extracted. He/she can interactively select which should be allowed or denied, or even which ones he/she doesn't care about. In a preferred embodiment of the invention, a proposed such generalized rule is generated corresponding to each log entry with matrix 90. The user can then determine whether to accept the generalized rule or the default specific rule. Ultimately, then, based on the user's selections a final rules set established which the administrator can then use to program the firewall. This final rules set can then be stored in another location 93 for convenient accessibility.

With reference again to FIG. 3, and as mentioned above, offline flow 80 may also incorporate procedures for evaluating the NAT rules and DHCP recommendations at 83 and 84, respectively. The default NAT rules are also preferably based, in part, on input 64 provided by the user within the configuration file. As discussed above, if proper parameters are set in the configuration file, the internal LAN addresses and network masks observed during online processing will be presented to the network administrator as a possible rule within storage location 91. If the administrator accepts at 83 any or all of the recommended NAT'ing which is proposed, this too will be added to the final rules in database 93. Similarly, any DHCP activity which is observed across the network link during online flow 70 may be presented to alert the administrator of a possible need for an internal DHCP server. As shown in the figure, any such recommendations, however, need not be stored outside location 92.

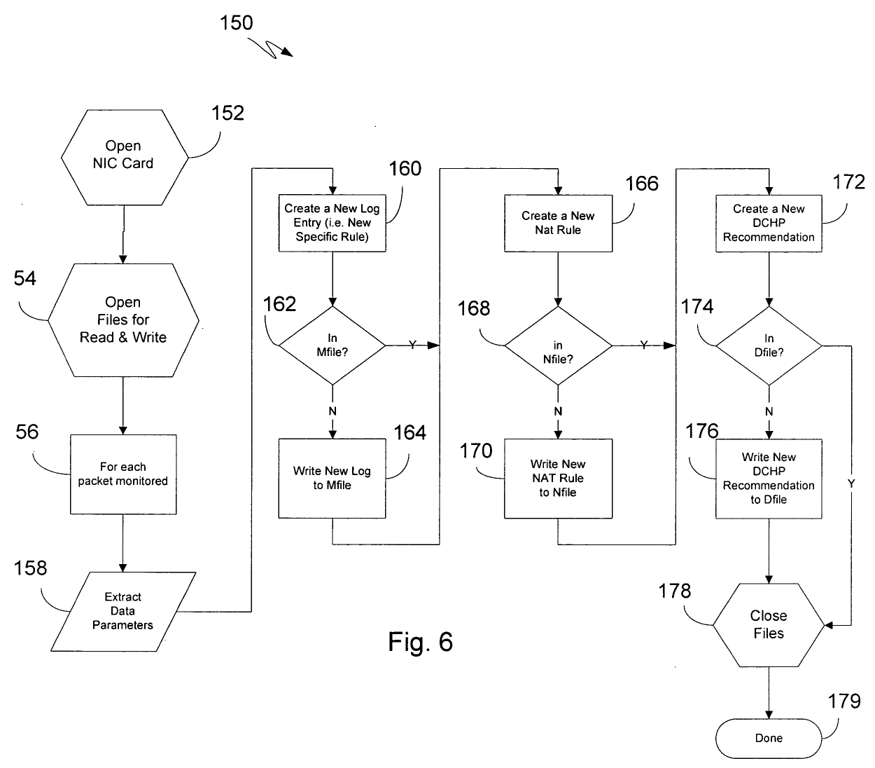

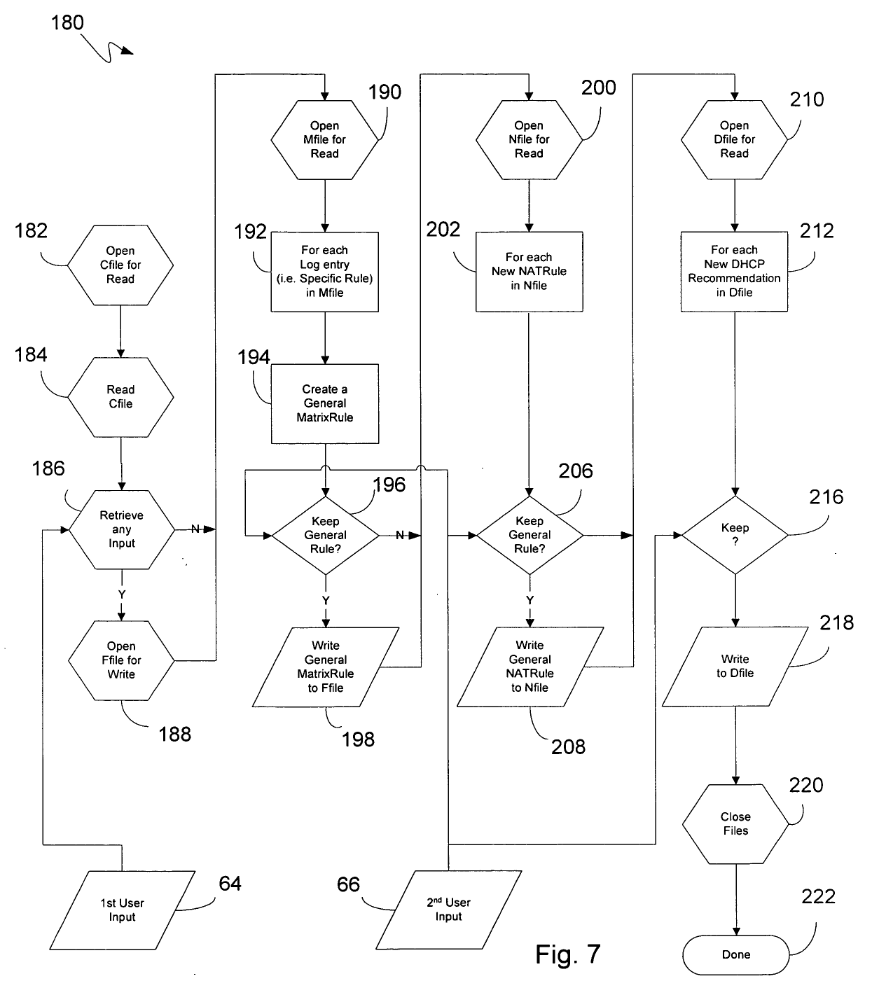

Having described in some detail the functional flow for configuring the firewall according to the present invention, reference is now made to FIGS. 6 and 7 which represent high level flowcharts for implementing, respectively, the online and offline processing functions for the firewall configuration methodology of the invention. With initial reference to FIG. 6, the online flow 150 begins with opening of a network interface card (NIC) 152 in promiscuous mode. Files are opened at 154 for read and write capabilities. These preferably include: a first file referred to as a matrix file (Mfile) for containing the log entries; a second file referred to as a NAT rules file (Nfile) for containing the proposed NAT rules; and third file referred to as a DHCP file (Dfile) for containing the proposed DHCP recommendations.

For each packet monitored at 156, the appropriate data parameters are extracted at 158. A new log entry is created at 160 and a determination is made at 162 as to whether this new log entry is in the Mfile. If not, the new log entry is written to Mfile at 164. In either case, the online process optionally proceeds at 166 to create a new NAT rule, if desired based on the configuration parameters. A determination is then made at 168 as to whether this new NAT rule is within the Nfile. If not, it is written to the Nfile at 170. In either case, and again based on first user input as contained in the configuration file, a new DCHP recommendation may be optionally created at 172, and a determination is made at 174 as to whether this new recommendation is in the Dfile. If not, it is written to Dfile at 176. In either case, the various files are then closed at 178 and online process 150 completes 179.

According to the offline flow 180 as shown in FIG. 7, the configuration file (Cfile) is opened for reading at 182 and subsequently read at 184. Any first user preferences 64, as discussed above, which correspond to the global set of firewall configuration parameters, are retrieved from the configuration file at 186. A final rules file containing the final filter parameters, is then opened at 188. At 190, the matrix file (Mfile) is opened for reading. For each log entry encountered at 192 a general rule is created at 194, also referred to herein as a proposed filter parameter. A determination is then made at 196 based on the second user input 66 whether to accept or reject the proposed filter rule. If it is to be accepted, it is written to the Mfile at 198. After recursively checking each log entry, flow 180 optionally proceeds at 200 to open the NAT rule file (Nfile) for reading. For each NAT rule encountered in this file at 202, a determination is made at 206, based also on user preferences 66, whether the associated NAT rule will be accepted or rejected. If it is to be accepted, it is written to the Nfile at 208. Otherwise, it is discarded. Once all of the rules within the Nfile have been recursively checked, flow 180 optionally proceeds at 210 to open the DHCP file (Dfile) for reading. For each new DHCP recommendation in the Dfile which is encountered at 212, a determination is then interactively made with the user at 216 as to whether the user wishes to accept or reject this recommendation. If so, it is written to Dfile at 218. In either case, once all of the recommendations in the Dfile have been recursively checked, offline flow 180 proceeds at 220 to close all of the aforementioned files, and thereafter completes at 222.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method for configuring filter parameters for a network firewall, comprising:
receiving first user input corresponding to a global set of firewall configuration parameters;
monitoring network traffic traversing a network segment, the network traffic characterized by a stream of data packets;
extracting, from each of said data packets, associated information corresponding to a core set of data parameters;
storing the associated information as a respective log entry in a database, thereby to generate a database of log entries;
establishing a set of proposed filter parameters from said log entries and the global set of firewall configuration parameters;
generating, from said set of proposed filter parameters, a set of final filter parameters based on second user input.

2. A method according to claim 1 whereby the first user input is stored in a configuration file.

3. A method according to claim 2 whereby the first user input corresponds to a user's desire to either restrict or allow transmission of network traffic along the network segment based on packet direction.

4. A method according to claim 2 whereby the first user input corresponds to a user's desire, with respect to each inbound data packet traversing the network segment, to either restrict or allow packet transmission based on a group of filtering criteria selected from one or more of a source IP address, a destination IP address, a source LAN, a destination LAN, a source IP port, a destination IP port, a protocol and a time.

5. A method according to claim 2 whereby the first user input corresponds to a network administrator's desire, with respect to each outbound data packet traversing the network segment, to either restrict or allow packet transmission based on group of filtering criteria selected from one or more of a source IP address, a destination IP address, a source LAN, a destination LAN, a source IP port, a destination IP port, a protocol and a time.

6. A method according to claim 1 whereby the network traffic is monitored using a network sniffer.

7. A method according to claim 6 whereby said network sniffer is tcpdump.

8. A method according to claim 1 whereby the core set of data parameters includes one or more of each data packet's associated source IP address, destination IP address, source LAN, destination LAN, source IP port, destination IP port, protocol and time.

9. A method according to claim 1 whereby each of the final filter parameters is generated after interactively interfacing with a user to receive the second user input.

10. A method according to claim 1 whereby said second user input corresponds to a user's desire to either accept or reject each of said proposed filter parameters.

11. A method for configuring filter parameters for a network firewall, comprising:
(a) while online:
(i) extracting, from each of a plurality of data packets traversing a network segment, associated information corresponding to a core set of data parameters;
(b) storing the associated information within a database as a respective log entry; and
(c) while offline:
(i) establishing, from log entries with said database, a set of proposed filter parameters based upon first user input; and
(ii) generating, from said set of proposed filter parameters, a set of final filter parameters based on second user input.

12. A method according to claim 11 whereby the first user input corresponds to a user's desire to either restrict or allow transmission of network traffic along the network segment based on packet direction.

13. A method according to claim 11 whereby the first user input corresponds to a user's desire, with respect to each inbound data packet traversing the network segment, to either restrict or allow packet transmission based on a group of filtering criteria selected from one or more of a source IP address, a destination IP address, a source LAN, a destination LAN, a source IP port, a destination IP port, a protocol and a time.

14. A method according to claim 13 whereby the first user input corresponds to a network administrator's desire, with respect to each outbound data packet traversing the network segment, to either restrict or allow packet transmission based on group of filtering criteria selected from one or more of a source IP address, a destination IP address, a source LAN, a destination LAN, a source IP port, a destination IP port, a protocol and a time.

15. A method according to claim 11 whereby the core set of data parameters includes each data packet's associated source IP address, destination IP address, source LAN, destination LAN, source IP port, destination IP port, protocol and time.

17. A method according to claim 11 whereby said second user input corresponds to a user's desire to either accept or reject each of said proposed filter parameters.
